(19) United States
(12) Patent Application Publication
(10) Pub. No.: US 2010/0175285 A1
(43) Pub. Date: Jul. 15, 2010

(54) STEAM IRON COMPRISING A SCALE INDICATOR

(75) Inventor: Marcus-Christian Wiedemann, Erbach (DE)

Correspondence Address: BROWDY AND NEIMARK, P.L.L.C.;624 NINTH STREET, NW, SUITE 300, WASHINGTON, DC, 20001-5303, US

(73) Assignee: Rowenta Werke GmbH, Offenbach (DE)

(21) Appl. No.: 12/295,202

(22) PCT Filed: Mar. 7, 2007
(86) PCT No.: PCT/IB2007/000608

§ 371 Date: Sep. 29, 2008

(30) Foreign Application Priority Data
Mar. 31, 2006 (FR) 06 02828

(51) Int. Cl. D06F 75/10; H05B 1/02

(52) U.S. Cl. 38/77.1; 219/494

(57) ABSTRACT

Steam iron comprising a scale indicator (10) and comprising a heating body (3) including a steam chamber (30) for producing steam, characterized in that it comprises means for calculating the electrical energy used by the iron and means which activate said scale indicator (10) when the calculated energy exceeds a predetermined threshold value.

The present invention relates to a household steam iron comprising a heating body provided with a steam chamber and more particularly refers to a household iron having a scale formation indicator making it possible to alert the user to the need for carrying out a maintenance operation.

There is known, from the patent application EP 1 045 932, a steam iron provided with a steam chamber supplied with a pump in which a scale formation indicator is activated after a predetermined time of use of the iron, the latter having means allowing to measure the cumulative time of use of the steam iron. In an improved alternative embodiment, the scale formation indicator is activated only after a predetermined operating time of the pump so as to have a better precision on the state of scaling of the iron.

Such a scale formation indicator has the advantage of encouraging the user to regularly carry out an operation of self-cleaning of the iron to evacuate the particles of tartar, or scale, or fur accumulated in the steam chamber.

However, such a method of activation of the scale formation indicator presents the disadvantage of being not very representative of the real state of calcification of the iron in its simplest embodiment and of being relatively expensive in its most complex variant, this variant being in addition unusable on steam irons comprising a simple drip device in place of the pump to feed the steam chamber.

The invention which follows aims at mitigating these disadvantages by providing a steam iron provided with a scale formation indicator in which the indicator is activated by means of a method of activation being able to be used on the simplest steam irons and allowing to obtain a better correspondence between the real state of scaling of the iron and the activation of the scale formation indicator while remaining simple and economical to produce.

The goal of the invention is achieved by a steam iron having a scale formation indicator and comprising a heating body containing a steam chamber for the production of steam, wherein it comprises means making it possible to calculate electric energy consumed by the iron and means serving to activate said scale formation indicator when the calculated energy exceeds a previously determined threshold.

Such an iron, in which the activation of the scale formation indicator is based on the calculation of energy consumption, makes it possible to obtain a better estimate of the state of scaling of the iron. In effect, in an iron for producing steam by means of a steam chamber, most of the energy consumed is devoted to the vaporization of water.

According to another characteristic of the invention, the heating body has an electric heating resistance whose operation is controlled by a thermostat and the iron comprises means to measure the cumulative time during which the thermostat supplies the heating resistance electrically.

According to another characteristic of the invention, the means to measure the cumulative time of operation of the heating resistance are integrated into an electronic circuit controlling the activation of the scale formation indicator, this electronic circuit receiving from the thermostat information relating to whether or not power is being supplied to the heating resistance.

According to another characteristic of the invention, the iron comprises means to calculate the quantity of energy consumed by the heating resistance, the scale formation indicator being activated when the quantity of energy consumed by the heating resistance exceeds a preliminarily determined threshold.

According to another characteristic of the invention, the iron comprises means to calculate the quantity of energy consumed to produce steam and the scale formation indicator is activated when said quantity of energy consumed for vaporization exceeds a preliminarily determined threshold.

According to another characteristic of the invention, the energy consumed to produce steam is calculated while subtracting, from the energy consumed by the heating resistance, an estimate of the energy necessary for the dry ironing of a textile at the assigned temperature of the thermostat.

According to still another characteristic of the invention, the energy necessary for the dry ironing of a textile at the regulating temperature of the thermostat is estimated by integrating over time the standard power necessary for the dry ironing of a textile at the regulating temperature of the thermostat, the value of this power being determined starting from values stored in a memory of the electronic circuit.

According to another characteristic of the invention, the threshold of activation of the scale formation indicator is modulated as a function of the degree of hardness the water introduced into the steam chamber, which is indicated by the user.

According to still another characteristic of the invention, the iron comprises a button whose actuation allows, when the scale formation indicator is activated, reinitialization of the calculation of the consumed electric energy.

According to still another characteristic of the invention, the button for reinitializing also constitutes a button for self-cleaning causing the abrupt arrival of a large quantity of water into the steam chamber.

One will understand better the goals, aspects and advantages of this invention from the description given hereafter of a particular embodiment of the invention, presented as a non-limiting example, while referring to the annexed drawing in which:

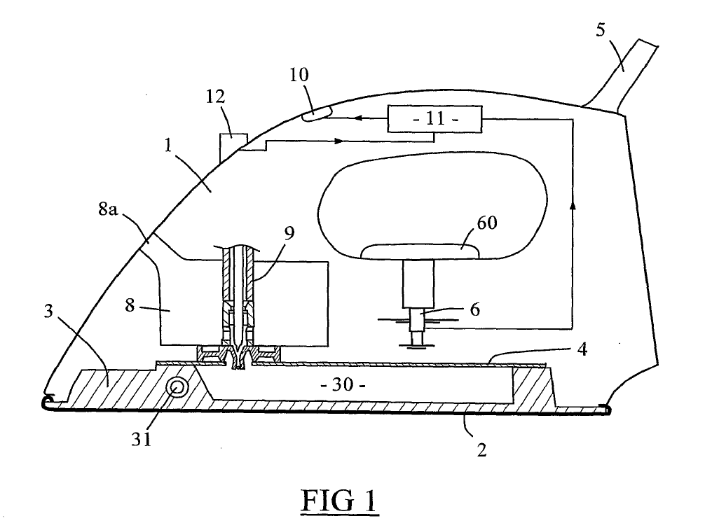

FIG. 1 is a diagrammatic view in longitudinal cross section of a steam iron according to one particular embodiment the invention.

Only the elements necessary for an understanding of the invention have been shown.

The iron, represented schematically in FIG. 1, comprises a case 1 disposed above a soleplate 2 provided with holes for the outlet of steam, not shown in the FIGURE. Soleplate 2 is in thermal communication with a heating body 3 having a steam chamber 30 closed conventionally by a plate 4.

Heating body 3 comprises a heating resistance 31 supplied with current by a thermostat 6 in thermal communication with the heating body, thermostat 6 ensuring the temperature control of soleplate 2 around an assigned temperature defined by the user by means of a button 60. The iron is connected to the electrical supply mains by a cord 5.

In a manner known per se, case 1 contains a water reservoir 8 provided with a filling opening 8a opening at the front face of the iron and has a drip device 9 that provides a passage for water from reservoir 8 towards the steam chamber 30, this device conventionally having an opening whose cross section can be reduced by a needle.

In order to warn the user of the need for carrying out a descaling operation on the iron, the latter comprises a scale formation indicator constituted by a light 10 that is activated by an electronic circuit 11. This electronic circuit 11 is advantageously fed with electricity by the electrical supply mains when cord 5 of the steam iron is connected to the mains.

More particularly according to the invention, electronic circuit 11 is connected to thermostat 6 and receives from the latter information relating to the periods of supply of electricity to heating resistance 31.

From this information, electronic circuit 11 contains a microprocessor that measures the electric energy consumed by heating resistance 31 from the first use of the iron. This measurement is taken advantageously by integrating with respect to time the power for the heating resistance 31, which is for example about 2000 W, during the operating time of heating resistance 31, this operating time being determined directly starting from the time of closing of thermostat 6.

The accumulation of the energy consumed is stored in a memory of electronic circuit 11, preferably a nonvolatile memory such as a flash memory or EEPROM. In an alternative, electronic circuit 11 can also have a self-contained power source, such as a battery or a capacitor, to preserve the data in memory when supply cord 5 of the steam iron is disconnected from the mains.

When the accumulation of the energy consumed by heating resistance 31 reaches a predetermined threshold, electronic circuit 11 activates light 10, for example in a blinking manner, to invite the operator to carry out a descaling operation.

The user is then invited to carry out an operation of descaling the iron by setting for example thermostat 6 to the maximum temperature and by pressing on a self-cleaning button 12 provided on the iron so as to cause, in a manner known per se, an abrupt arrival of water from reservoir 8 towards steam chamber 30 in order to obtain a detachment of the particles of tartar, or scale, and their evacuation through the steam holes of soleplate 2.

In a preferred manner, electronic circuit 11 is connected to self-cleaning button 12 and carries out, during actuation of the self-cleaning button, a resetting to zero of the memory in which is stored the accumulation of the energy consumed by heating resistance 31.

By way of example, the value of the threshold from which light 10 is activated is obtained experimentally by causing the iron to operate with full steam with fairly hard water and by measuring the threshold from which the state of scaling of the iron requires a descaling operation.

Such an activation of the scale formation indicator starting from a measurement of the sum of the energy consumed by the heating resistance makes it possible to obtain, in a simple manner, a good correspondence between the real state of scaling of the iron and the activation of the scale indicator light. In effect, the vaporization of water for the production of steam being a substantial energy consumer, the scale formation indicator light of the iron will be activated much more quickly when the iron is used for steam ironing than when the iron is used for dry ironing. However, the scale formation in the iron depends primarily on the quantity of water which is vaporized in the steam chamber.

In an improved alternative of the embodiment previously described, the determination of the state of scaling of the iron will be further improved by calculating the energy consumed by resistance 31 used only to vaporize water. One thus obtains a very good estimate of the quantity of water vaporized in the steam chamber, the latter being in direct correlation with the energy expended for vaporization.

In this alternative, electronic circuit 11 calculates in an approximate way energy used to vaporize water while subtracting, from the accumulated energy consumed by resistance 31, an estimate of energy necessary to maintain soleplate 2 at the temperature set at thermostat 6 during a dry ironing of the textile.

This energy necessary to dry ironing is estimated by integrating over time a standard power necessary for dry ironing of the textile for the set temperature. In an advantageous manner, the value of this standard power is determined by correlation starting from standard values of power, stored in a memory of electronic circuit 11, for different temperature values of soleplate 2.

As an example, these standard power values are about 100 W for a soleplate temperature close to 100° C. and 300 W for a soleplate temperature close to 200° C.

Electronic circuit 11 then simply calculates, starting from these values, the energy consumed for the vaporization of water while integrating, over the operating time of heating resistance 31, determined starting from thermostat 6, the power consumed by heating resistance 31 from which is subtracted the standard power used to maintain soleplate 2 at the set, or assigned, temperature.

When the energy consumed for the vaporization of water in the steam chamber exceeds a predetermined threshold, corresponding for example to the energy necessary to evaporate 15 liters of water, the scale formation indicator is then activated.

In an advantageous manner, the iron can also comprise means making it possible for the user to indicate the degree of hardness of the water introduced into the reservoir, so that the water hardness can be taken into account by the electronic circuit 11 to adapt the activation threshold of scale formation indicator light 10 as a function of the water hardness.

Such an alternative makes it possible to further improve the correspondence between activation of the scale formation indicator and the real state of scaling of the iron. In particular, with such an alternative, the activation of the scale formation indicator will not take place, or only after a very long period of use of the iron, if the user essentially performs dry ironing.

Of course, the invention is by no means limited to the embodiment described and illustrated, which has been given only as an example. Modifications remain possible, in particular from the point of view of the constitution of the various elements or by substitution of technical equivalents, without leaving for all that the field of protection of inventions.

Thus, in an alternative embodiment of the invention, the mechanical thermostat of the iron could be replaced by an electronic thermostat connected to temperature sensors.

1. Steam iron including a scale formation indicator (10) and comprising a heating body (3) containing a steam chamber (30) for the production of steam, wherein it comprises means making it possible to calculate electric energy consumed by the iron and means serving to activate said scale formation indicator (10) when the calculated energy exceeds a previously determined threshold.

2. Steam iron according to claim 1, wherein said heating body (3) comprises an electric heating resistance (31) whose operation is controlled by a thermostat (6) and the iron comprises means to measure the cumulative time during which the thermostat (6) supplies the heating resistance (31) electrically.

3. Steam iron according to claim 2, wherein said means to measure the cumulative time of operation of the heating resistance are integrated into an electronic circuit (11) controlling the activation of the scale formation indicator (10), said electronic circuit (11) receiving information from the thermostat (6) relating to whether or not power is being supplied to the heating resistance (31).

4. Steam iron according to claim 1, wherein the iron comprises means to calculate the quantity of energy consumed by the heating resistance (31) and the scale formation indicator (10) is activated when the quantity of energy consumed by the heating resistance (31) exceeds a preliminarily determined threshold.

5. Steam iron according to claim 1, wherein the iron comprises of the means to calculate the quantity of energy consumed to produce steam and the scale formation indicator (10) is activated when said quantity of energy consumed for vaporization exceeds a preliminarily determined threshold.

6. Steam iron according to claim 5, wherein the energy consumed to produce steam is calculated while subtracting, from the energy consumed by the heating resistance (31), an estimate of the energy necessary for the dry ironing of a textile at the assigned temperature of the thermostat.

7. Steam iron according to claim 6, wherein the energy necessary for the dry ironing of a textile at the regulating temperature of the thermostat (6) is estimated by integrating over time the standard power necessary for the dry ironing of a textile at the regulating temperature of the thermostat (6), the value of this power being determined starting from values stored in a memory of the electronic circuit (11).

8. Steam iron according to claim 1, wherein the threshold of activation of the scale formation indicator (10) is modulated as a function of the degree of hardness of the water introduced into the steam chamber (30) which is indicated by the user.

9. Steam iron according to claim 1, wherein said iron comprises a button (12) whose actuation allows, when the scale formation indicator (10) is activated, reinitialization of the calculation of the consumed electric energy.

10. Steam iron according to claim 9, wherein said button (12) for reinitializing also constitutes a button for self-cleaning causing the abrupt arrival of a large quantity of water into the steam chamber.
